(19) United States
(12) Patent Application Publication
(10) Pub. No.: US 2011/0029495 A1
(43) Pub. Date: Feb. 3, 2011

(54) FILE TRANSFER BANDWIDTH CONSERVATION

(76) Inventor: Arul Selvan Rama Samy, Thottampatti (IN)

Correspondence Address: SCHWEGMAN, LUNDBERG & WOESSNER/NOVELL, PO BOX 2938, MINNEAPOLIS, MN, 55402, US

(21) Appl. No.: 12/510,786

(22) Filed: Jul. 28, 2009

(51) Int. Cl. G06F 17/30; G06F 15/16

(52) U.S. Cl. 707/695; 707/E17.01; 709/201

(57) ABSTRACT

Apparatus, systems, and methods may operate to receive first changes made to an unmodified version of a file at a first location and to store the first changes (included in the modified version of the file) on a node, such as a server, without a first conflict being detected. When a second conflict is detected between the first changes and second changes made to the unmodified version of the file at a second location, operations may include transmitting from the node a portion of the modified version (including the first changes, but not the second changes). This portion can be transmitted from the node to the second location to resolve the second conflict. An unmodified version of the file can be maintained at the second location where the second changes are made. Additional apparatus, systems, and methods are disclosed.

### BACKGROUND

Servers sometimes operate to permit file sharing between networked clients. Thus, an unmodified file may be stored at the server, and downloaded to many clients at the same time. These clients may each operate in a disconnected mode to make changes to the unmodified file, after which the changes may be uploaded to the server. However, if a first client makes first changes to the original file that are subsequently saved to the server before second changes are made to the original file and saved by a second client, a conflict may arise when the second client attempts to upload the second changes to the server so that the second changes can be saved. File transfers used to resolve the conflict can operate to reduce the available network bandwidth.

### SUMMARY

In various embodiments, apparatus, systems, and methods that support file transfer bandwidth conservation are provided. For example, in some embodiments, a reduction in the amount of file transfer activity can be realized by receiving the first changes made to an unmodified version of the file at a first location and storing the first changes (included in the modified version of the file) on a node, such as a server, without a first conflict being detected. Then, when a second conflict is detected between the first changes and second changes made to the unmodified version at a second location, operations may include transmitting from the node a portion of the modified version (including the first changes, but not the second changes). This portion can be transmitted from the node to the second location to resolve the second conflict by making comparisons with an unmodified version of the file that is maintained at the second location when the second changes are made. Additional embodiments are described, and along with the foregoing examples, will be set forth in detail below.

### BRIEF DESCRIPTION OF THE DRAWINGS

FIG. 1 is a flow diagram illustrating methods of file transfer bandwidth conservation according to various embodiments of the invention.

FIG. 2 is another flow diagram illustrating methods of file transfer bandwidth conservation according to various embodiments of the invention.

FIG. 3 is a block diagram of apparatus and systems according to various embodiments of the invention.

FIG. 4 is a block diagram of an article of manufacture, including a specific machine, according to various embodiments of the invention.

### DETAILED DESCRIPTION

Resolving conflicts that arise when multiple disconnected parties act to edit a single file presents a variety of challenges. Some of these challenges may be addressed by implementing intelligent data transfer that is based on comparisons of the content to be communicated. For example, an original copy of the file as it exists on a server can be maintained and versioned on a client for use during conflict detection-induced comparison operations. When changes are made to the file on the server, these changes can be compared with the original copy on the client so that only the changes present on the server are downloaded to the client. In this way, the changes made at the client to the original file are not also downloaded (as occurs in conventional systems), conserving file transfer bandwidth.

For example, consider two clients, Alice and Bob, operating in conjunction with a document file server. To begin, Alice creates a document and uploads a copy of the document file to the server. Bob later downloads a copy of the document file from the server. At this point, Alice, Bob, and the server all have the same (original) copy of the document.

Assume that Alice and Bob now work on editing the document using their individual copies. Alice then uploads a new, modified copy of her document to the server. Bob later attempts to upload his modified copy to the server, which creates a conflict with the copy that's already been uploaded by Alice. Bob's workstation detects this conflict when the upload operation is attempted.

A program to determine differences between files that reside on a client and those that reside on the server may be executed by the Bob's client. For example, the Rsync program may be used to determine which blocks in any document have been modified, as between a file that resides on the client and a file that resides on the server. The Rsync program may then operate to transfer only the blocks that differ back to the server. Thus, a file difference program (e.g., Rsync program) can be used to determine all differences between the file copy on the server and Bob's modified copy.

In conventional systems, Bob's client would download from the server the blocks changed by Alice, as well as his own changes. For example, assume that the original (unmodified) document file has 100 blocks. Further assume that Alice changes the file to add blocks 101-110, while Bob edits the file to change blocks 90-100. After Bob's client detected the conflict induced by attempting to upload the changed block 90-100, he might attempt to resolve the conflict by using his client and Rsync to download both Alice's changes (blocks 101-110) and his own changes (blocks 90-100), which gives a total of 20 blocks downloaded.

The embodiments described herein operate quite differently. For example, the server may be used to maintain one copy of the document, and each client may be used to maintain two copies: an unmodified, original copy of the file, and a modified copy. Thus, Bob maintains two copies at his client workstation: Version 1 (the unmodified original, created by Alice and stored on the server prior to either party making modifications), and Version 2 (Bob's modified version of the unmodified original).

In this way, the file difference program (e.g., Rsync program) can operate on the unmodified version stored on the client, to compare that version with what is stored on the server. Thus, if Version 1 (original) is used to construct Version 2 (Bob's version) at Bob's workstation, then only 10 blocks are downloaded to Bob from the server, since the only data that is missing at Bob's workstation are the 10 blocks (blocks 101-110) added by Alice's changes. In this example, the number of blocks downloaded according to the embodiments described herein is 50% less than might otherwise occur in conventional systems. Therefore, file transfer bandwidth is conserved by versioning the modified file at the client workstation.

After the changes made by Alice are downloaded to Bob, he has a choice of selecting one of the two modified versions of the file as the new version to be saved to the server, or merging all of the changes together, with the result constituting a new version that is uploaded to the server. For example, in this case Bob may choose between Alice's modified version, with added blocks 101-110 (and without his changes to blocks 91-100); or his own version, with changed blocks 91-100 (and without Alice's added blocks 101-110); or a merged version constructed by merging the changes to blocks 91-100 with the addition of blocks 101-110.

If Alice's version is chosen, then no uploading occurs. If the merged version is chosen, then only blocks 91-100 are uploaded. If Bob's version is chosen, then only blocks 91-100 are uploaded, and blocks 101-110 are deleted at the server. Thus, file conflicts that arise between multiple users working at multiple workstations, or even a single user operating multiple clients, can be resolved using less bandwidth by implementing this mechanism.

In some embodiments, whenever the client node successfully uploads the file to the server (e.g., when no conflict is detected), the file is versioned in the client node. This file version may be saved in the client work area, or perhaps to a mass storage device or an archive server that serves to archive the last successfully uploaded file. In some cases, only this most recent version of the file is maintained, and the prior (unmodified) version of the file is destroyed. In many embodiments, the node (e.g., server) that operates to download a copy of the most recent version of the file to the other nodes (e.g., clients) operates as a passive node. This is, it does not initiate file transfers to the other nodes.

The mechanism described herein can be used as an extension to an existing file system, or as a script/tool on a server. It may be useful to prevent unnecessary read/write activity to slower storage media, such as single hard disks, and disk arrays.

Therefore, many embodiments of the invention may be realized, and each can be implemented in a variety of architectural platforms, along with various operating and server systems, devices, and applications. Any particular architectural layout or implementation presented herein is therefore provided for purposes of illustration and comprehension only, and is not intended to limit the various embodiments.

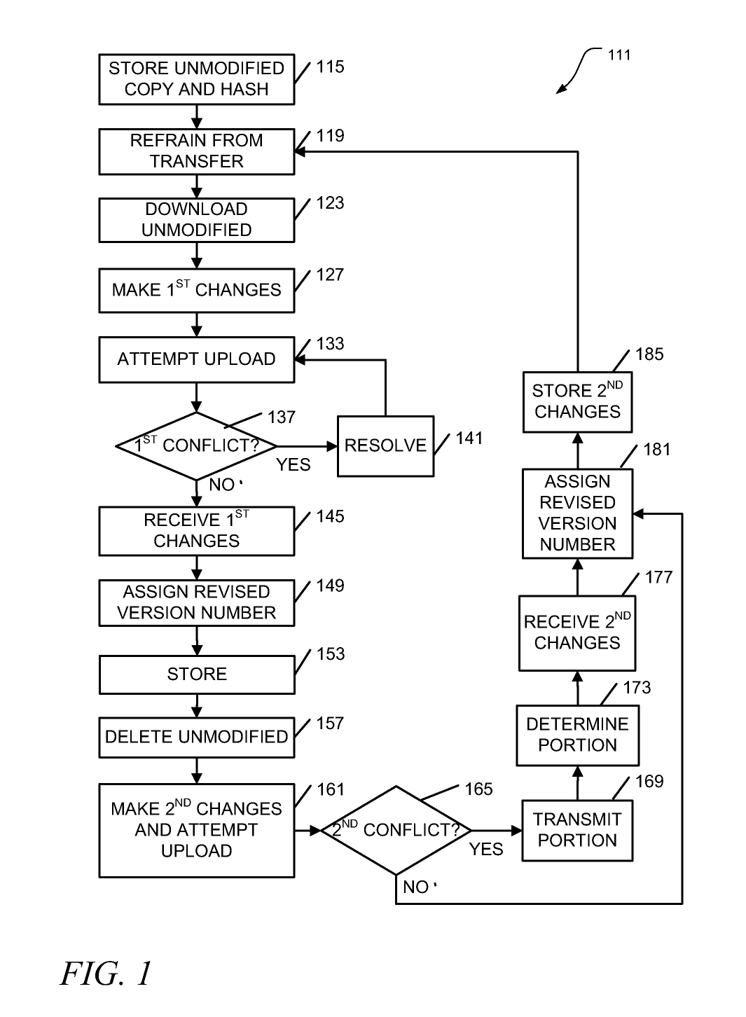

FIG. 1 is a flow diagram illustrating methods 111 of file transfer bandwidth conservation according to various embodiments of the invention. The methods 111 are implemented in a machine-accessible and readable medium and are operational over processes within and among networks. The networks may be wired, wireless, or a combination of wired and wireless. The methods 111 may be implemented as instructions, which when accessed by a specific machine, perform the processing depicted in FIG. 1. Given this context, file transfer bandwidth conservation is now discussed with reference to FIG. 1.

In some embodiments, as viewed from the perspective of a node, such as a server, a processor-implemented method 111 to execute on one or more processors that perform this method (of conserving file transfer bandwidth) may begin with storing the unmodified version of the file, along with a hash of the data file blocks in the unmodified version, on a server. Thus, the method 111 may begin at block 115 with storing a copy of the unmodified version of the file at the server, and storing a hash of each file data block in the unmodified version on the server, perhaps separately from the copy of the unmodified version.

The server can operate as a passive server that does not initiate file transfers. Thus, the method 111 may continue on to block 119 with refraining from initiating a transfer of the file to a first location (e.g., comprising a first client), or a second location (e.g., comprising a second client). Indeed, in some embodiments, the method 111 may include refraining from initiating a transfer of the file to any other location, responding only to requests to transfer the file.

Thus, the server may operate to provide (e.g., download) the unmodified version of the file, perhaps upon receiving a request for a copy of the file from a particular location, before any changes are made. Therefore, the method 111 may include, at block 123, downloading all of the unmodified version of the file to a variety of locations (e.g., the first location and the second location) prior to any changes being made.

The method 111 may go on to block 127 to include making first changes in the copy of the unmodified filed maintained at the first location. After the changes have been completed, the method may include attempting to upload the first changes to the server at block 133. If a first conflict is detected at block 137, then the method 111 may include resolving the first conflict at block 141, and continuing on to block 133 with further attempts to upload data from the first location to the server at bock 133.

Once the first changes can be uploaded to the server without a first conflict being detected at block 137, the first changes are received at the server at block 145. Thus, in many embodiments, the method 111 comprises receiving first changes made to an unmodified version of a file at a first location, to store the first changes included in a modified version of the file on a server without a first conflict being detected (e.g., between operations conducted on the file at the first location and operations conducted on the file at another location).

The modified version on the server can be assigned a revised version number, updated from the version number originally assigned to the unmodified version of the file. Thus, the method 111 may continue on to block 149 with assigning a revised version number to the modified version of the file on the server that is different from an original version number associated with the unmodified version.

Once it is determined that the first changes can be received at the server without conflict, the modified version including the first changes can be saved, and the unmodified version deleted. Thus, before or after a revised version number is assigned at block 149, the method 111 may include storing the revised version on the server at block 153. The method 111 may go on to block 157 to include deleting the unmodified version at the server after the first changes are received at the server without the first conflict being detected.

At some point, the method 111 may include making second changes to the original, unmodified file and attempting to upload the changes to the server at block 161. If no second conflict is detected at block 165, then the method 111 may continue on to block 181 with assigning a revised version number to the file. Thus, the modified version at the second location can be assigned a revised version number, updated from the version number originally assigned to the unmodified version of the file, which is also maintained at the second location. Therefore, the activity at block 181 may include assigning a revised version number to a file including the second changes that is different from an original version number associated with the unmodified version.

The method 111 may continue on to block 185 from block 181 with storing the second changes (if those changes are selected to be part of the modified version of the file) on the server at block 185.

When a second conflict is detected at between the first changes and the second changes (made to the unmodified version at a second location) at block 165, the method 111 may include, at block 169, transmitting from the server the portion of the modified version including the first changes and not the second changes to the second location to resolve the second conflict, wherein an unmodified version of the file is maintained at the second location when the second changes are made.

The method 111 may go on to block 173 to include determining the portion of the modified version that has been modified by determining differences between the unmodified version of the file at the second location and the modified version on the server (since the changes that created the modified version on the server have been transmitted at block 169).

The determined portion may be received as second changes at block 177, and then at block 181, a revised version number can be assigned to the file that is chosen as the modified file (e.g., the file with only the first changes, only the second changes, or a merged version that includes both first and second changes, as noted above). The method 111 may then continue on to block 185 from block 181.

In summary, the method 111, from the view point of the server, may operate as follows: each location (e.g., client) maintains an unmodified version of the file where independent changes can be made. When a conflict between two sets of changes is detected at one of the locations, only changes between the unmodified version maintained at that location and the modified version that is on the server are downloaded to the location where the conflict is detected. Thus, the second conflict is determined as between the unmodified version at a particular location, and the latest version stored on the server. Therefore, the second conflict can be detected at the second location (per block 165) by determining the difference between the modified version on the server and the unmodified version at the second location. Other embodiments may be realized.

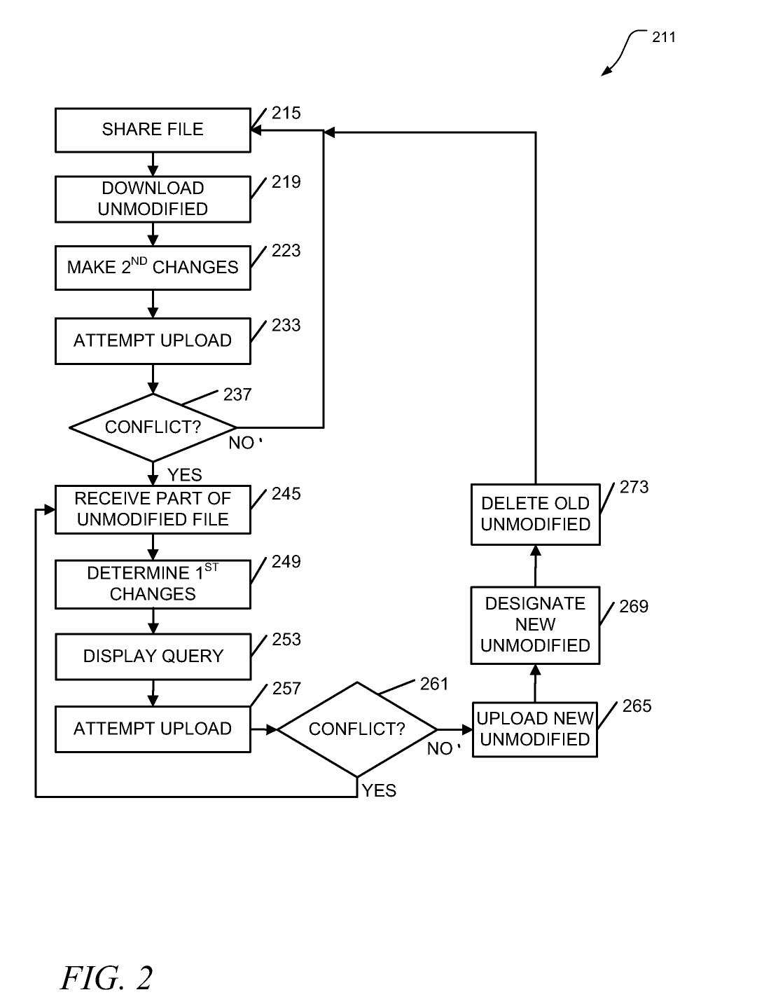

For example, FIG. 2 is another flow diagram illustrating methods 211 of file transfer bandwidth conservation according to various embodiments of the invention. In this case, the methods 211 comprise the activities of a system of nodes, including a networked system that comprises a server and multiple clients. The methods 211 are implemented in a machine-accessible and readable medium, and are operational over processes within and among networks. The networks may be wired, wireless, or a combination of wired and wireless. The methods 211 may be implemented as instructions, which when accessed by a specific machine, perform the processing depicted in FIG. 2.

A processor-implemented method 211 that can be executed on one or more processors that perform this method may begin at block 215 with sharing a file between a first location and a second location, perhaps comprising a first client workstation and a second client workstation, respectively. The method 211 may thus include, at block 219, downloading all of the unmodified version of the file to a variety of locations (e.g., the first location and the second location) prior to any changes being made.

Here, as noted previously, conflicts can arise when a file that is shared between two client users via a server is independently modified. Consider, as an example of what may occur, that first changes have been made to a copy of the unmodified file maintained at a first location. Further assume that second changes are later made to a copy of the unmodified file maintained at a second location. In this case, the method 211 may go on to block 233 to include attempting to upload at least the second changes made to an unmodified version of a file from the second location to a server.

If the first changes made at the first location have not yet been uploaded to the server, then no first conflict may be detected at block 237, and the method 211 may continue on to sharing the file at block 215. However, if the first changes are transmitted to the server and saved prior to the attempt at uploading the second changes at block 233, then a second conflict may be detected at block 237. Therefore, the method 211 may include, at block 237, detecting a second conflict between the second changes and first changes made to the unmodified version of the file at the first location, where the first changes are stored as part of a modified version of the file at the server.

The method 211 may thus continue from block 237 when a second conflict is detected in this manner, to include, at block 245, receiving from the server at least a part of the modified version at the second location to resolve the second conflict. The received part of the modified version would usually not include the second changes, as these are already known at the second location (since the unmodified version of the file is maintained at the second location when the second changes are made). Again, it is assumed that the modified version causing the second conflict was previously stored on the server without a first conflict being detected between operations conducted on the file at the first location and operations conducted on the file at some other location

In summary, the method 211 from the viewpoint of the second location may thus operate as follows: the second location (e.g., a client) maintains an unmodified version of the file and changes are made to this unmodified version independently. When a conflict is detected between the changes made at the second location and what is stored on the server, only changes between the unmodified version and the version on the server are downloaded to the second location.

To determine the extent of the changes made at the first location, the second location may operate to compare the unmodified version maintained at the second location with the modified version stored at the server. Thus, the method 211 may go on to include, at block 249, determining, at the second location, the first changes by comparing the unmodified version and the modified version. A program such as Rsync can be used at the second location to determine the extent of the changes made at the first location. Thus, the activity at block 249 may comprise executing an Rsync program.

As is the case with the method 111 shown in FIG. 1, the user at the second location may opt to resolve the detected conflict manually, if desired. For example, the method 211 may comprise, at block 253, displaying, at the second location, a query to elicit selection between resolving the second conflict by merging the first changes and the second changes, or saving only the first changes, or saving the second changes and discarding the first changes, as noted previously.

At this point, another attempt can be made to upload the changes that have been chosen from the second location at block 257. If a conflict is detected at block 261, the method 211 may continue on to block 245. In some embodiments, if the first changes are saved at the second location and the second changes are discarded, no further attempts to upload the changes are made.

Once the second changes have successfully been uploaded to the server at block 265 without generating a detected conflict at block 261, a new unmodified version of the file can be designated (e.g., comprising the second changes). Thus, the method 211 may include, at block 269, designating a revised file including the second changes as a new unmodified version of the file to be maintained at the second location, wherein a copy of the revised file is also stored at the server. Once the second changes have successfully been uploaded to the server without generating a conflict, the unmodified version of the file can also be deleted at the second location. Thus, the method 211 may further comprise, at block 265, uploading the second changes to the server without detecting a third conflict at block 261, and then deleting the unmodified version at the second location, at block 273.

The methods described herein do not have to be executed in the order described, or in any particular order. Moreover, various activities described with respect to the methods identified herein can be executed in repetitive, serial, or parallel fashion. The individual activities of the methods shown in FIGS. 1 and 2 can also be combined with each other and/or substituted, one for another, in various ways. Information, including parameters, commands, operands, and other data, can be sent and received in the form of one or more carrier waves. Thus, many other embodiments may be realized.

The methods of file transfer bandwidth conservation shown in FIGS. 1 and 2 can be implemented in a computer-readable storage medium, where the methods are adapted to be executed by one or more processors. Further details of such embodiments will now be described.

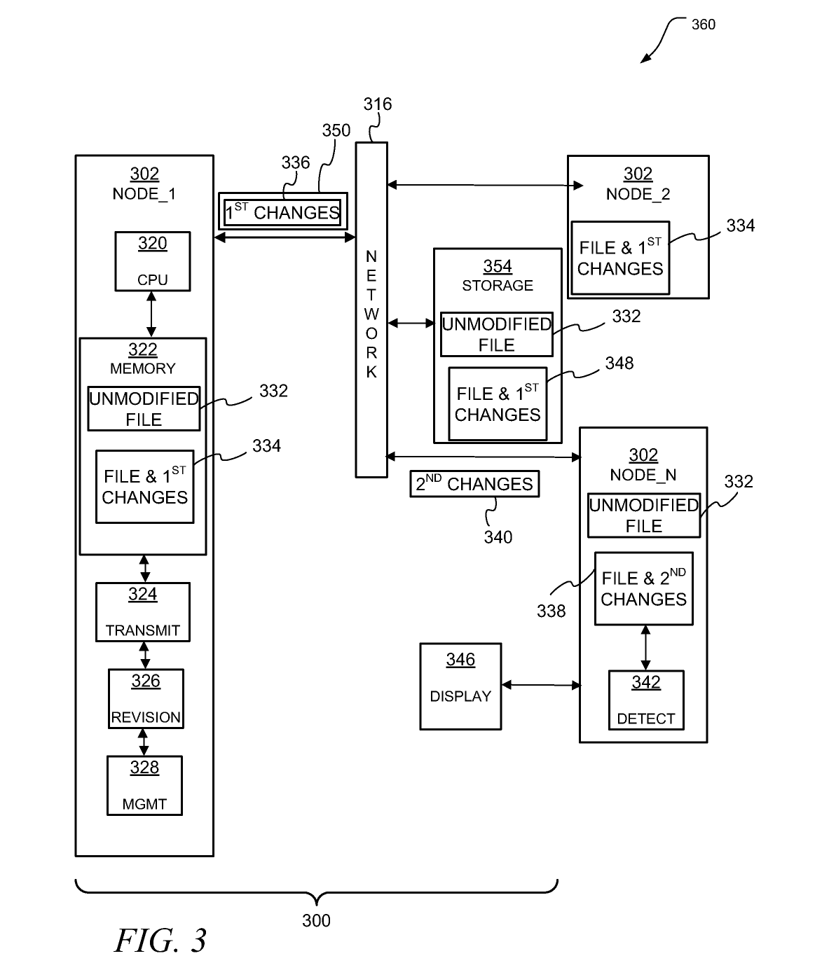

FIG. 3 is a block diagram of apparatus 300 and systems 360 according to various embodiments of the invention. Here it can be seen that an apparatus 300 used to implement file transfer bandwidth conservation may comprise one or more processing nodes 302, one or more processors 320, and memory 322. In one or more of the nodes 302, additional modules may be included, as will be subsequently described.

The processing nodes 302 may comprise physical machines or virtual machines, or a mixture of both. The nodes 302 may also comprise networked entities, such servers and/or clients. Each of the nodes 302 shown in FIG. 3 may comprise some or all of the components shown in any of the other nodes 302.

In some embodiments, then, an apparatus 300 may comprise a node 302 (e.g., NODE_1) having a memory 322 to store first changes 336 made to an unmodified version of a file 332 at a first location (e.g., NODE_2) after no first conflict is detected between operations conducted on the file 332 at the first location and operations conducted on the file 332 at another location (e.g., NODE_N), the first changes 336 may be included within a modified version of the file 334.

The apparatus 300 may further comprise a data transmission module 324 to transmit from the node (e.g., NODE_1) a portion 350 of the modified version of the file 334 including the first changes 336 to the second location (e.g., NODE_N) to resolve a second conflict. An unmodified version of the file 332 can be maintained at the second location when the second changes are made. If this is the case, then the second conflict be detected between the first changes 336 and the second changes 340 made to the unmodified version 332 at the second location, while file transfer bandwidth is conserved, as noted previously. Thus, the portion 350 sent from the node (e.g., NODE_1) usually does not include the second changes 340.

The nodes 302 can operate to assign new version numbers to modified versions of the file as they are stored there. Thus, the apparatus 300 may further comprise a revision module 326 to assign a revised version number to the modified version of the file 334 on the node that is different from an original version number assigned to the unmodified version 332.

The nodes 302 can also operate to delete prior versions of the file, once changes have been received without generating conflicts. Thus, the apparatus 300 may further comprise a file management module 328 to delete the unmodified version 332 at the node after the first changes 336 are received at the node 302 without a first conflict being detected.

The apparatus 300 might comprise a server, including a physical server or a virtual server, as well as a desktop computer, a laptop computer, a PDA, or a cellular telephone. The apparatus 300 may also comprise a client, or an independent processing node. In some embodiments, multiple clients (e.g., NODE_2 and NODE_N) can interact with a server (e.g., NODE_1) that operates to manage modifications made to files, and to store and retrieve content to/from a storage medium 354.

The apparatus 300 may house the storage medium 354, or not (as shown). Thus, in some embodiments, the apparatus 300 comprises the storage medium 354. The storage medium 354 may comprise an array of disks, including a RAID (redundant array of inexpensive disks) system. Further embodiments may be realized.

For example, it can be seen that a system 360 that operates to conserve file transfer bandwidth may comprises multiple instances of the apparatus 300. The system 360 might also comprise a cluster of nodes 302, including physical and virtual nodes. Thus, in some embodiments, a system 360 may comprise at least three separate processing entities: a first entity (e.g., NODE_1) to store an unmodified version of a file 332, and two other entities (e.g., NODE_2 and NODE_N) that operate to independently modify the file 332.

Therefore, a system 360 may comprise a second client node (e.g., NODE_N) coupled to a processor to upload at least second changes 340 made to an unmodified version of a file 332 to a server (e.g., NODE_1), the second client node including a conflict detection module 342 to detect a second conflict between the second changes 340 and first changes 336 made to the unmodified version of the file 332 at a first client node (e.g., NODE_2). The first changes 336 can be stored as part of a modified version of the file 334 at the server, and the second client node can operate to receive from the server a part 350 of the modified version 334 to resolve the second conflict, wherein the part 350 does not include the second changes 340. Again, the unmodified version of the file 332 can be maintained at the second client node when the second changes are made.

The system 360 may include any number of nodes. Thus the system 360 may include NODE_1, NODE_2, . . . , NODE_N in some embodiments, where N is a positive integer.

A display 346 may be used at any of the nodes 302, such as at the second client node (e.g., NODE_N) to display the first changes 336 in the modified version of the file 334, and the second changes 340 made at the second client node. A user viewing the two sets of changes can choose whether to merge them, or to discard one of them. Thus, the system 360 may further comprise a display 346 coupled to the second client node to display the modified version and the second changes, among other information.

The apparatus 300 and system 360 may be implemented in a machine-accessible and readable medium that is operational over one or more networks 316. The networks 316 may be wired, wireless, or a combination of wired and wireless. The apparatus 300 and system 360 can be used to implement, among other things, the processing associated with the methods 111 and 211 of FIGS. 1 and 2, respectively. Modules may comprise hardware, software, and firmware, or any combination of these. Additional embodiments may be realized.

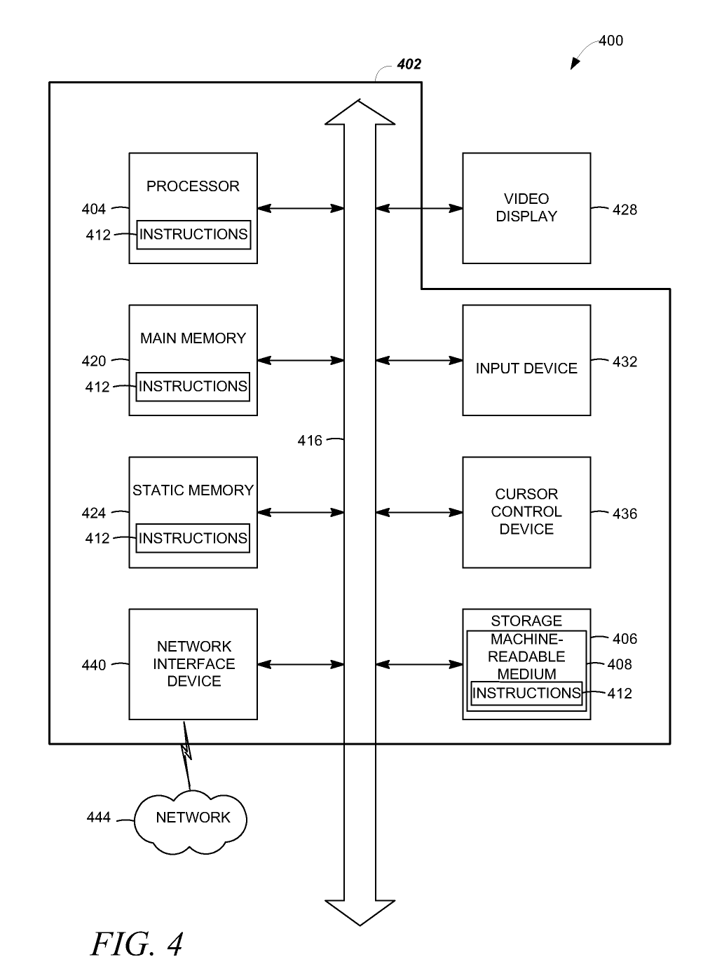

For example, FIG. 4 is a block diagram of an article 400 of manufacture, including a specific machine 402, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 400 of manufacture, such as a computer, a memory system, a magnetic or optical disk, some other storage device, and/or any type of electronic device or system may include one or more processors 404 coupled to a machine-readable medium 408 such as a memory (e.g., removable storage media, as well as any memory including an electrical, optical, or electromagnetic conductor) having instructions 412 stored thereon (e.g., computer program instructions), which when executed by the one or more processors 404 result in the machine 402 performing any of the actions described with respect to the methods above.

The machine 402 may take the form of a specific computer system having a processor 404 coupled to a number of components directly, and/or using a bus 416. Thus, the machine 402 may be similar to or identical to the apparatus 300 or system 360 shown in FIG. 3.

Turning now to FIG. 4, it can be seen that the components of the machine 402 may include main memory 420, static or non-volatile memory 424, and mass storage 406. Other components coupled to the processor 404 may include an input device 432, such as a keyboard, or a cursor control device 436, such as a mouse. An output device 428, such as a video display, may be located apart from the machine 402 (as shown), or made as an integral part of the machine 402.

A network interface device 440 to couple the processor 404 and other components to a network 444 may also be coupled to the bus 416. The instructions 412 may be transmitted or received over the network 444 via the network interface device 440 utilizing any one of a number of well-known transfer protocols (e.g., HyperText Transfer Protocol). Any of these elements coupled to the bus 416 may be absent, present singly, or present in plural numbers, depending on the specific embodiment to be realized.

The processor 404, the memories 420, 424, and the storage device 406 may each include instructions 412 which, when executed, cause the machine 402 to perform any one or more of the methods described herein. In some embodiments, the machine 402 operates as a standalone device or may be connected (e.g., networked) to other machines. In a networked environment, the machine 402 may operate in the capacity of a server or a client machine in server-client network environment, or as a peer machine in a peer-to-peer (or distributed) network environment.

The machine 402 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 402 is illustrated, the term “machine” shall also be taken to include any collection of machines that individually or jointly execute a set (or multiple sets) of instructions to perform any one or more of the methodologies discussed herein.

While the machine-readable medium 408 is shown as a single medium, the term “machine-readable medium” should be taken to include a single medium or multiple media (e.g., a centralized or distributed database, and/or associated caches and servers, and or a variety of storage media, such as the registers of the processor 404, memories 420, 424, and the storage device 406 that store the one or more sets of instructions 412. The term “machine-readable medium” shall also be taken to include any medium that is capable of storing, encoding or carrying a set of instructions for execution by the machine and that cause the machine 402 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to increase the performance of servers and mass storage systems by conserving file transfer bandwidth via a reduction in duplicative data transfer operations. More efficient allocation of data processing resources may result.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a node having a memory to store first changes made to an unmodified version of a file at a first location after no first conflict is detected between operations conducted on the file at the first location and operations conducted on the file at another location, the first changes included within a modified version of the file; and
a data transmission module to transmit from the node a portion of the modified version of the file including the first changes to the second location to resolve a second conflict, wherein the unmodified version of the file is maintained at the second location when the second changes are made, wherein the second conflict is detected between the first changes and the second changes made to the unmodified version at the second location, and wherein the portion does not include the second changes.

2. The apparatus of claim 1, further comprising:
a revision module to assign a revised version number to the modified version of the file on the node that is different from an original version number assigned to the unmodified version.

3. The apparatus of claim 1, further comprising:
a file management module to delete the unmodified version at the node after the first changes are received at the node without the first conflict being detected.

4. A system, comprising:
a second client node coupled to a processor to upload at least second changes made to an unmodified version of a file to a server, the second client node including a conflict detection module to detect a second conflict between the second changes and first changes made to the unmodified version of the file at a first client node, the first changes stored as part of a modified version of the file at the server, wherein the second client node is to receive from the server the part of the modified version to resolve the second conflict, the part not including the second changes, wherein the unmodified version of the file is maintained at the second client node when the second changes are made, and wherein the modified version is stored on the server without a first conflict being detected between operations conducted on the file at the first client node and operations conducted on the file at another location.

5. The system of claim 4, further comprising:
the first client node.

6. The system of claim 4, further comprising:
a display coupled to the second client node to display the modified version and the second changes.

7. A processor-implemented method to execute on one or more processors that perform the method, comprising:
receiving first changes made to an unmodified version of a file at a first location to store the first changes included in a modified version of the file on a node without a first conflict being detected between operations conducted on the file at the first location and operations conducted on the file at another location; and
when a second conflict is detected between the first changes and second changes made to the unmodified version at a second location, transmitting from the node a portion of the modified version including the first changes and not the second changes to the second location to resolve the second conflict, wherein the unmodified version of the file is maintained at the second location when the second changes are made.

8. The method of claim 7, further comprising:
assigning a revised version number to the modified version of the file on the node that is different from an original version number associated with the unmodified version.

9. The method of claim 7, wherein the second conflict is detected at the second location by determining a difference between the modified version on the node and the unmodified version at the second location.

10. The method of claim 7, further comprising:
assigning a revised version number to a file including the second changes that is different from an original version number associated with the unmodified version.

11. The method of claim 7, further comprising:
determining the portion of the modified version by determining differences between the unmodified version of the file at the second location and the modified version on the node.

12. The method of claim 7, further comprising:
deleting the unmodified version at the node after the first changes are received at the node without the first conflict being detected.

13. The method of claim 7, further comprising:
refraining from initiating a transfer of the file to the first location comprising a first client, or the second location comprising a second client.

14. The method of claim 7, further comprising:
downloading all of the unmodified version of the file to the second location prior to the second changes being made.

15. The method of claim 7, further comprising:
storing a copy of the unmodified version of the file at the node; and
storing a hash of each file data block in the unmodified version on the node, separately from the copy of the unmodified version.

16. A processor-implemented method to execute on one or more processors that perform the method, comprising:
attempting to upload at least second changes made to an unmodified version of a file from a second location to a node;
detecting a second conflict between the second changes and first changes made to the unmodified version of the file at a first location, the first changes stored as part of a modified version of the file at the node; and
receiving from the node at least the part of the modified version at the second location to resolve the second conflict, the part not including the second changes, wherein the unmodified version of the file is maintained at the second location when the second changes are made, and wherein the modified version was previously stored on the node without a first conflict being detected between operations conducted on the file at the first location and operations conducted on the file at another location.

17. The method of claim 16, further comprising:
determining, at the second location, the first changes by comparing the unmodified version and the modified version.

18. The method of claim 17, wherein the comparing further comprises:
executing an Rsync program.

19. The method of claim 16, further comprising:
uploading the second changes to the node without detecting a third conflict; and
deleting the unmodified version at the second location.

20. The method of claim 16, further comprising:
designating a revised file including the second changes as a new unmodified version of the file to be maintained at the second location, wherein a copy of the revised file is also stored at the node.

21. The method of claim 16, further comprising:
sharing the file between the first location and the second location comprising a first client workstation and a second client workstation, respectively.

22. The method of claim 16, further comprising:
displaying, at the second location, a query to elicit selection between resolving the second conflict by merging the first changes and the second changes, saving the first changes and discarding the second changes, or saving the second changes and discarding the first changes.
